(19) United States
(12) Patent Application Publication
(10) Pub. No.: US 2022/0244574 A1
(43) Pub. Date: Aug. 4, 2022

(54) INTERCHANGEABLE EYEWEAR SYSTEM

(71) Applicant: Madison T. BAILEY, Radnor, PA (US)

(72) Inventor: Madison T. BAILEY, Radnor, PA (US)

(21) Appl. No.: 17/586,854

(22) Filed: Jan. 28, 2022

Related U.S. Application Data
(63) Continuation-in-part of application No. 29/768,444, filed on Jan. 29, 2021.
(60) Provisional application No. 63/202,580, filed on Jun. 16, 2021.

(51) Int. Cl. G02C 11/02; G02C 1/06; G02C 5/14

(52) U.S. Cl. CPC G02C 11/02; G02C 5/14; G02C 1/06

(57) ABSTRACT

The present invention is directed to an interchangeable eyewear system and a method of making an interchangeable eyewear system. The interchangeable eyewear system more particularly includes flexible chains or cords releasably connected to the eyewear frame and ornamental charm using screw clasps, magnetic clasps or a combination thereof, wherein the chains or cords are adaptable to be pulled over or draped over the ears of the wearer.

### CROSS-REFERENCE TO RELATED APPLICATIONS

The present application claims benefit of U.S. Provisional Application No. 63/202,580, entitled INTERCHANGEABLE EYEWEAR SYSTEM, filed Jun. 16, 2021, and the present application is a continuation-in-part application of U.S. design patent application Ser. No. 29/768,444, entitled EYEWEAR SYSTEM, filed Jan. 29, 2021, which are incorporated herein by reference in their entirety.

### BACKGROUND OF THE INVENTION

Most available eyewear, including prescription eyeglasses and both prescription and non-prescription sunglasses, as well as magnifying glasses (readers), comprise a front and back portion of a frame. The back portion of the frame comprises the rigid temples (side members or stems), while the front portion of the frame comprises the frame rims that contain the lenses. The temple comprises a shaft extending towards the back of a wearer's head with a slight to pronounced bend for looping partially around the ears. Usually some type of bridge connects the two lens rims and rests on the nose of the wearer, bearing most of the weight of the glasses. Some types of frames also have nose pieces attached to the front frame, usually to the rims, for a more comfortable weight bearing fit. In some instances, the nose piece comprises nose pads connected to pad arms that are connected to the rims. On some frames, the nose pads are plastic and built into the rims of the frame. Other types of eyeglasses are frameless where wires are inserted into the edges of the lenses to hold the lenses together and attach to the temples or stems. All of these elements can be typically found on traditional eyeglass and sunglass frames and there are a myriad of different types of lens rims, bridges and nose pieces available. These configurations hold the glasses to the head, while keeping the lens portion in front of the eyes.

What all of these different styles of eyewear usually have in common is an end piece, also known as a head piece or an elbow, that connects each rigid temple to the front of the frame, usually to the lens rim. On rimless glasses, the end piece is usually connected directly to the lens itself. The end piece is a small part of the front frame that extends outward or backward from the lenses to connect the front frame to the temples usually via a hinge. The hinge is a moveable joint usually located on the inside of the temple that allows the temple to fold inward. The hinge is usually connected to the temple member via a screw that inserts inside an opening in the end piece.

Stemless eyewear has also been available but is much less common, where the frame containing the lenses is kept in place with cords or chains rather than rigid temples or stems.

The present invention is an improvement over available stemless eyewear.

### SUMMARY OF THE INVENTION

In accordance with the present invention, there is provided an interchangeable eyewear system, comprising a frame and flexible temple members in the form of decorative cords or chains, adaptable to extend to and over the ears of the wearer. Preferably, the frame also contains lenses, such as sunglass lenses, which could be polarized or non-polarized, or reading lenses, which could be of any type of magnitude. The eyewear system of the present invention is also suitable for insertion of prescription lenses. The flexible chain or cord is adapted to connect on its distal end to an ornamental charm or pendant, and the cords or chains as well as the pendants or charms are interchangeable with similarly adapted cords/chains and charms/pendants.

### BRIEF DESCRIPTION OF THE DRAWINGS

FIG. 1 is a perspective view of one embodiment of the invention showing the flexible temples made of chain, the screw clasps joining the proximal end of the chain to a ring, which ring is inserted into an opening in the end piece of the frame. The distal end of the chain is also visible, joined to another screw clasp, which is joined to a ring inserted into an opening in an ornamental charm.

FIG. 2A is a front view of the eyewear system of the present invention showing an example of a different type of ornamental charm from that shown in FIG. 1, attached to the distal end of the chain.

FIG. 2B is a side view of the eyewear system of FIG. 2A.

FIG. 2C is an enlarged, exploded partial top view of the eyewear system shown in FIGS. 2A and 2B with one chain fully extended.

FIG. 3A is a front view of the eyewear system of the present invention showing an example of a different type of ornamental charm attached to the distal end of the chain.

FIG. 3B is a side view of the eyewear system of FIG. 3A.

FIG. 4A is a front view of a further embodiment of the invention where the distal ends of both chains are joined to a first portion of a magnetic clasp and a second portion of the magnetic clasp is joined to a ring which is inserted into an opening in an ornamental pendant.

FIG. 4B is a side view of the embodiment shown in FIG. 4A. The proximal end of one of the chains is attached to a first portion of a magnetic clasp and a second portion of a magnetic clasp is joined to a ring inserted into an opening of an ornamental pendant is visible.

FIG. 5A is a front view of a further embodiment of the invention showing an example of yet another type of ornamental charm attached to the distal end of the chain. The magnetic clasps at the proximal ends and distal ends of the chains are clearly visible.

FIG. 5B is a magnified side view of the distal end of one of the chains of FIG. 5A. The two separate portions of the magnetic clasp are clearly visible, one portion connected to a ring at the distal end of a chain, and a second portion connected to a ring inserted into an opening of an ornamental charm.

### DETAILED DESCRIPTION OF THE PREFERRED EMBODIMENTS

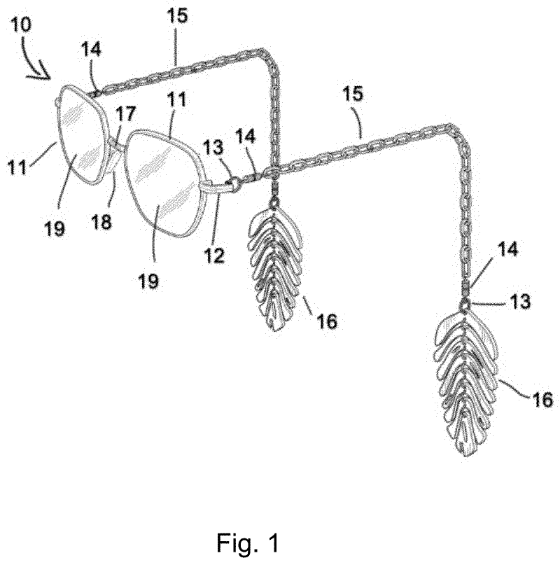

With reference to FIG. 1, a first embodiment of the invention is illustrated therein and it will be seen to include an interchangeable eyewear system generally designated by the reference number 10. The interchangeable eyewear system 10 includes a front frame comprising two lens rims 11, a bridge 17, a nose piece 18, and an end piece 12. All of these elements can be typically found on traditional eyeglass and sunglass frames and there are a myriad of different types and styles of lens rims, bridges and nose pieces available. The flexible side members 15 of the present invention comprise either a chain or cord of at least about 13 cm in length, with a range of about 13 to about 25 cm in length. Preferably, the length of the cords or chains is in the range of from about 15 to about 21 cm. The weight of the chain can be in the range of from about 4 to about 10 grams with a preferred range of from about 5 to about 8 grams.

Each chain or cord has a proximal end that connects to the frame, and a distal end that connects to an ornamental charm or pendant 16. The chains or cords are adaptable to be pulled towards and draped over the ears of a wearer and can be made of different types of materials such as metal or plastic. A preferred material for the chains is steel, including gold-plated steel or silver-plated steel, or even a precious metal such as gold or sterling silver. The chains are usually linked chains and the links can have many different types of shapes. Examples include a paper clip style chain, where each individual link is between about 5-10 mm in length, about 1.5 to 4 mm in width, and about 1-5 mm in thickness.

The cord can be made of a material such as fiber, including twisted fibers, plastic, leather or fabric in different colors, weaves, or patterns. For example, the cord can be a beaded cord, where the beads are connected to each other via a string or wire.

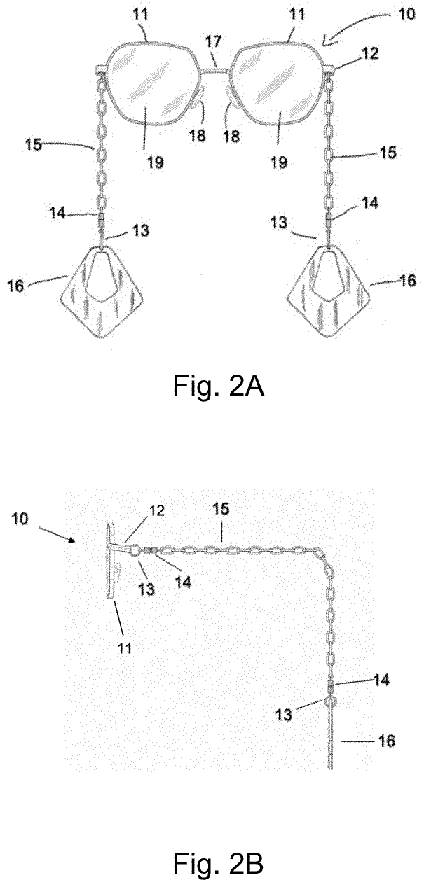

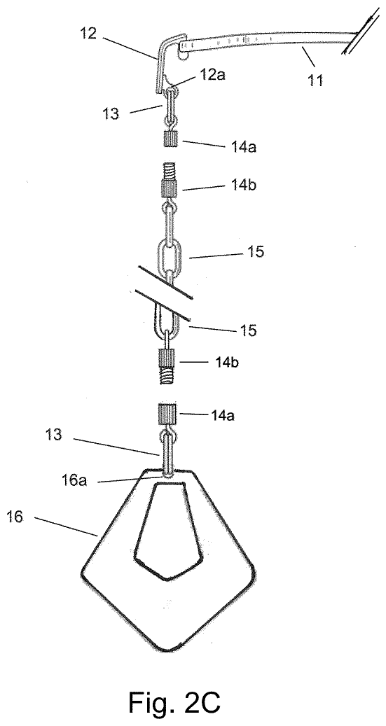

The proximal end (end closest to the front portion of the frame) of the chain or cord is connected to the lens or lens rim via an end piece 12, which as discussed above is a small part of the front frame that extends outward or backward from the lenses. Each end piece 12 has an opening into which a first pair of rings 13 is inserted. Only one end piece 12 and one ring 13 is inserted into an opening in an end piece is visible in FIG. 1. This first pair of rings is connected to a first portion of a first set of screw clasps 14. The first portions of the first set of screw clasps 14 have either an internally threaded portion or an externally threaded portion connected to the first pair of rings 13. A second portion of the first set of screw clasps is correspondingly internally or externally threaded in order to be releasably fastened to the first portion of the screw clasp and is attached to the proximal end of each chain or cord. In FIG. 1, the first portion of the screw clasp 14 is visible closest to the rims of the frame 11 and directly connected to the ring 13. This first portion of the screw clasp 14a can be seen as separate from the second portion of the screw clasp 14b in FIG. 2C.

The screw clasps may be connected directly to the end pieces without the use of rings; however, the rings provide added strength and flexibility to the connection between the frame and the chains or cords.

Screw clasps used in the eyewear of the present invention can be of various sizes. In a preferred embodiment of the invention, the length of a screw clasp with its two portions screwed together is in the range of from about 12 to about 18 mm. Preferably, the length of a screw clasp is about 15 mm, with the unscrewed internally threaded portion about 7.5 mm in length, and the unscrewed externally threaded portion about 9 mm in length. Screw clasps with both portions joined can weigh in the range of from about 0.1 to about 0.5 grams, with a preferred range of from about 0.3 to about 0.35 grams.

As shown in FIG. 1, a second pair of screw clasps is attached to and connects the distal ends of the chains to the decorative charm or pendant. This second pair of screw clasps is usually identical to the first pair of screw clasps. Thus, the first portion of the screw clasp is either internally or externally threaded and the second portion of the screw clasp will be correspondingly internally or externally threaded in order to be releasably fastened to each other. A first portion of the screw clasp is connected to the distal ends of the cords or chains and a second portion of the screw clasp is connected to a second pair of rings 13 (FIG. 1). Each ring 13 of this second pair of rings is inserted into an opening in the ornamental charm or pendant 16.

The rings 13 can vary in size measured by circumference or diameter, as long as the width of the ring fits into the opening of the end piece and the opening of the charm or pendant. Typical ring sizes are in the range of from about 0.25 to about 1.5 mm in thickness and about 5 to about 8 mm or about 3 to about 10 mm in diameter, but can run larger or smaller. Preferably the ring has a diameter of about 6.5 mm. The rings can either be jump rings (having a small gap) or split rings, which are fully enclosed. Preferably, the rings are split rings due to their increased strength and durability.

Alternatively, the screw clasps may be inserted directly into the openings of the pendants or charms; however, use of the rings provides added strength to the chain and charm or pendant connection as well as added pendency or dangling effect of the charm or pendant. The screw clasps used in the eyewear system of the present invention prove to be superior to any other type of clasp such as spring clasps because they are stronger and there is less of a chance that the screw clasps will become caught in a wearer's clothing, hair, or jewelry such as earrings or necklaces.

The charms or pendants can be of a myriad of different shapes and sizes and of any material, including but not limited to metal, plastic, wood, polyvinyl chloride (PVC), or cellulose acetate. In a preferred embodiment, an individual charm is made of cellulose acetate.

Preferably, the weight of an individual charm or pendant is in the range of from about 1.5 to about 5 g. Most preferably, the weight of charm or pendant is in the range of from about 2 to about 4 g.

In accordance with the present invention, the charms or pendants are interchangeable with other charms or pendants having the same portions of screw clasps attached thereto. For example, the charm or pendant on the distal end of a chain or cord can be unscrewed from the chain or cord and switched with another charm or pendant as long as the charm or pendant has the proper portion of screw clasp to mate and screw to the portion attached to the end of the chain.

The chains or cords are also interchangeable with other chains or cords having the same portions of screw clasps attached thereto. In a preferred embodiment, the interchangeable eyewear system includes at least two chains or cords, one on each side of the frame to hook behind the ear of the wearer. Additional chains or cords can be added if desired.

In accordance with the present invention, the total combined weight of the charms or pendants, the cords or chains, screw clasps, and in certain embodiments the rings, provide the requisite tension to keep the rims containing the lenses (or just the lenses in a rimless frame) securely in place on the nose of a wearer and aligned vertically in front of the eyes of the wearer. In other words the components of the system allow the frame or rims of the eyewear system to be aligned in the same visual plane as the eyes of the wearer. Other eyewear systems not having the total combined weight of the present invention will be too heavy in weight and cause the rims containing the lenses (or just the lenses in a rimless frame) to fall towards the head of the wearer where the lenses will no longer be aligned correctly in front of the eyes. Conversely, if the combined weight of the charms or pendants, the cords or chains, screw clasps, and in certain embodiments the rings, is not heavy enough, the rims containing the lenses (or just the lenses in a rimless frame) will fall away from the head of the wearer in a horizontal tilt and therefore will no longer be aligned correctly in front of the eyes. The lightweight feature of the preferred cellulose acetate charms is especially helpful in achieving the correct combined weight.

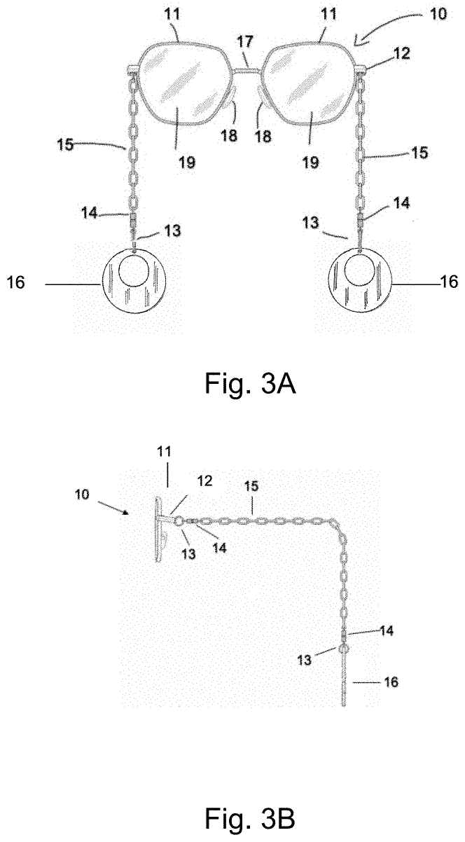

FIGS. 2A and 3A show further examples of the first embodiment of the invention. In both figures, lenses 19 inserted into the rims 11 are visible. The lens rims 11 and bridge 17 are clearly visible. The two end pieces 12 are also clearly visible as are both chains 15 and the second set of screw clasps 14 connected to a ring 13 inserted into an opening in an ornamental charm 16. In FIGS. 2A and 3A, the first set of rings and screw clasps at the proximal ends of the chains are hidden behind the end pieces 12. In FIGS. 2B and 3B, both sets of rings 13 and screw clasps 14 are clearly visible on one chain.

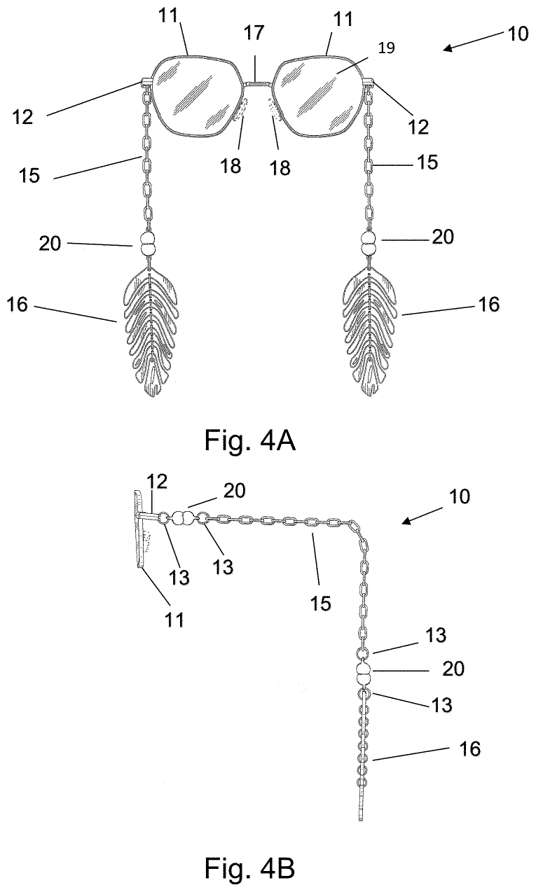

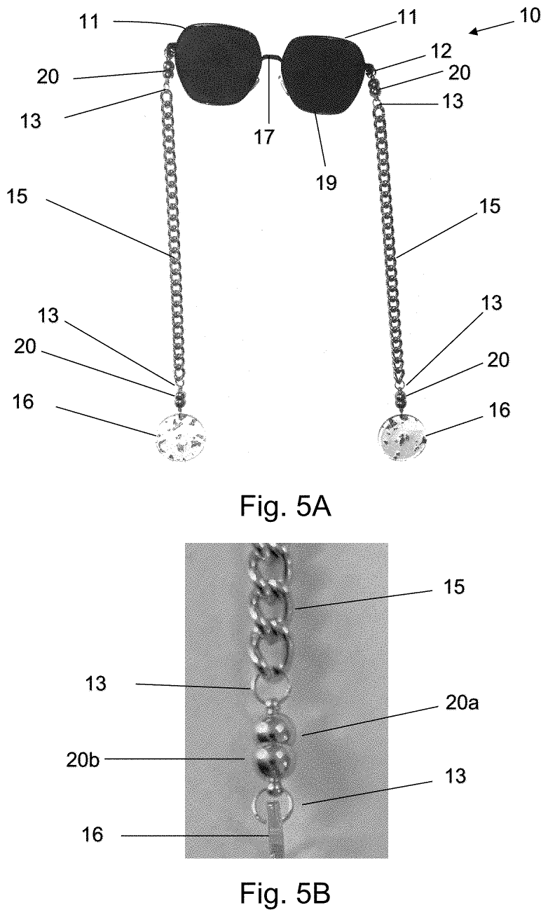

FIGS. 4A, 4B, 5A, and 5B illustrate a second embodiment of the invention. In this embodiment, rather than screw clasps, magnetic clasps 20 are used to join the proximal ends of the chains 15 to the end pieces 12 and to join the distal ends of the chains 15 to the ornamental charms or pendants 16. Magnetic clasps have two portions, each portion having opposite magnetic poles. FIG. 5B shows the two portions of a magnetic clasp, 20a and 20b. Various types of magnetic clasps may be used in this embodiment of the invention. The shape and size of the magnetic clasps for use in the present invention may vary and include but are not limited to spheres, circles, partial spheres, rectangles, squares, barrels, tubes, balls, double ball, oval, diamond, melon, and slides, all of which are well known in the art and readily available. The material of the magnetic clasps includes but is not limited to metal, plated steel, silver-finished brass, silver-plated steel, gold plated steel, gold-finished brass, etc. Magnetic clasps (both portions joined) for use in the present invention usually weigh anywhere in the range of from about 0.5 to about 3.5 g with a preferred weight range of about 1 to about 3 g. Examples of magnetic clasp sizes for use in the present invention include but are not limited to about 12 mm by 6 mm in length (barrels and double balls; see double ball magnetic clasp 20 in FIG. 4B, each ball being a first and a second portion 20a and 20b as shown in FIG. 5B), and about 10-13 mm in length with a 4-6 mm diameter (tubes).

As shown in FIG. 5A, four sets of magnetic clasps 20 are used in an eyewear system of the present invention. Each magnetic clasp has a first portion 20a and a second portion 20b as shown in FIG. 5B. A first pair of magnetic clasps has a first portion connected to opposite sides of the frame by a first pair of rings 13. Each ring 13 is inserted into an opening in an end piece 12 of the frame. FIG. 4B. A second portion of the first set of magnetic clasps is connected to the proximal end of each chain or cord by a second pair of rings 13, for releasably attaching each chain or cord to the end piece of the frame. This first pair of magnetic clasps 20 is hidden by the end pieces in FIG. 4A but is clearly visible in FIGS. 4B and 5A.

A second pair of magnetic clasps 20 has a first portion connected to the distal end of each cord or chain by a third set of rings 13 and a second portion connected to a fourth set of rings 13. FIGS. 4B and 5A. Each ring of the fourth set of rings 13 is inserted into an opening in the ornamental charm or pendant 16 for releasably attaching the charm or pendant to the distal end of the cord or chain. FIG. 5B. As with the screw clasps, the magnetic clasps can be inserted directly into openings in the end piece and in the charm or pendant. However, use of the rings provides added strength and flexibility to the chain and frame connection and charm or pendant connection as well as added pendency or dangling effect of the charm or pendant. The chains or cords are interchangeable with other chains or cords having the same portion of the magnetic clasp attached thereto. Similarly, the charms or pendants are interchangeable with other charms or pendants having the same portion of a magnetic clasp attached thereto. By same portion is meant a portion having the same magnetic polarity.

In accordance with the present invention, the combined weight of the charms or pendants, the cords or chains, the rings, and the magnetic clasps provide the requisite tension to keep the frame in place on the bridge of the nose of a wearer and aligned vertically in front of the eyes of the wearer.

The magnetic clasps are especially convenient and advantageous for wearers with arthritis in the hands or other ailments that affect functioning of the fingers/hands. The ability for quickly changing the cords or chains and charms or pendants by pulling the magnetic clasps apart and aligning the magnetic portions which quickly attach to each other by magnetic pull, is immediately apparent. The magnetic clasps are also convenient for people “on the go” e.g., rushing off to work, running to catch a train or bus, since switching chains or cords, and charms or pendants is simple and quick.

In accordance with the present invention, the charms or pendants are interchangeable with other charms or pendant having the same portions of releasable clasps and the chains or cords are interchangeable with other chains or cords having the same portions of releasable clasps. It is further contemplated that more than one type of releasable clasp can be used. In the preferred embodiments the type of releasable clasp can be selected from the group consisting of screw clasps, magnetic clasps or a combination thereof. For instance, a screw clasp can be used to connect the proximal end of the chain or cord to the frame and a magnetic clasp can be used to connect the distal end of the chair or cord to the charm or pendant.

The present invention also provides a method of making the interchangeable eyewear system using only a front portion of an eyeglass or sunglass frame. In other words, the front portion only of a frame can be manufactured and/or obtained without the temples or stems attached. Alternatively, the temples or stems from a full eyeglass or sunglass frame can be removed. The method comprises inserting a first ring 13 into a first opening 12a (FIG. 2c) in a first end piece 12 of the frame 11, said first ring 13 connected to a first portion 14a (FIG. 2c) of a first screw clasp 14 having internal or external threads. Preferably, the first portion of the first screw clasp is internally threaded for ease of attaching a chain or cord. A second ring 13 is inserted into a second opening 12a in a second end piece of the frame 11, said second ring connected to a first portion of a first screw clasp having internal or external threads.

Alternatively, the screw clasp can be inserted directly into an opening in the frame end piece without a ring.

Two chains or cords 15 of at least about 13 cm in length are each connected to a second portion of a first screw clasp 14b having corresponding internal or external threads so that the first and second portions of the screw clasps are joinable to connect the ends of the cords or chains to the end pieces 12 of the frame. A first portion of a second screw clasp 14 having internal or external threads is connected to the distal end of each of the cords or chains 15. A second portion of a second screw clasp 14b having corresponding internal or external threads is connected to a second set of rings 13 and each ring is inserted into an opening 16a of a pendant or charm (FIG. 2D). Alternatively, the second portion of the second screw clasp can be inserted directly into an opening in the charm or pendant without using a ring.

In this method, the chains or cords are interchangeable with other chains or cords having the same portions of screw clasps attached thereto and the charms or pendants are interchangeable with other charms or pendants having the same portions of screw clasps attached thereto. Thus, each internally threaded portion of a screw clasp will mate with and be releasably fastenable to an externally threaded portion of the screw clasp.

The combined weight of the charms or pendants, the cords or chains, the rings, and screw clasps provide the requisite tension to keep the frame in place on the nose of a wearer and aligned vertically in front of the eyes of a wearer when the cords or chains are pulled toward and draped over the ears of the wearer.

The present invention provides a further method of making an interchangeable eyewear system comprising soft temples or stems made of cord or chain. The method comprises inserting a first ring into a first opening in a first end piece of the frame, so that the first ring is connected to a first portion of a magnetic clasp. A second ring is into a second opening in a second end piece of the frame, the second ring also connected to a first portion of a magnetic clasp. The proximal ends of two chains or cords of at least about 13 cm in length are connected to a second portion of the first magnetic clasp. The first and second portions of the first magnetic clasp are polar opposites and therefore joinable to connect the proximal ends of the cords or chains to the end pieces of the frame. A first portion of a second pair of magnetic clasps is also connected to the distal ends of each of the cords or chains.

A second portion of the second magnetic clasp is connected to a ring inserted into an opening in a pendant or charm. The first and second portions of the second pair of magnetic clasps are polar opposite and therefore joinable to connect the pendant or charm to the distal portion of the chains or cords.

Alternatively, any of the magnetic clasps may be joined to the end piece of the frame, to the proximal ends of the cords or chains, to the distal ends of the cords or chains and to the charms or pendants without the use of rings. In addition, the proximal ends of the cords or chains may be attached to the eyeglass or sunglass frame by an element other than an end piece, such as by a hook, eye, clasp, loop, or ring fastened to the frame or lenses of the glasses.

Since it is the combined weight of the charms or pendants, the cords or chains, the rings, and screw clasps or magnetic clasps that provide the requisite tension to keep the frame securely in place on the nose of a wearer and aligned vertically in front of the eyes of a wearer when the cords or chains are pulled toward and draped over the ears of the wearer, if rings are not used, adjustments can be made by the wearer to achieve the requisite tension. For example, longer chains may be used to make up for the difference in weight of the eyewear system when rings are not used.

The detailed description of the invention having been set forth herein, it is known that there can be departure from the embodiments described without departing from the true scope of the invention.

What is claimed is:

1. An interchangeable eyewear system comprising:
(a) an eyeglass or sunglass frame adapted for insertion of lenses therein or containing lenses inserted therein;
(b) one or more ornamental charms or pendants;
(c) at least two flexible chains or cords each chain or cord having a proximal end that connects to the frame, and a distal end that connects to said at least one ornamental charm or pendant; said chains or cords adaptable to be pulled towards and draped over the ears of a wearer; and
(d) releasable clasps connecting said chains or cords to said frame and said ornamental charms or pendants, wherein said releasable clasps are screw clasps, magnetic clasps or combination thereof;
wherein the chains or cords are interchangeable with other chains or cords having said releasable clasps attached thereto; wherein the charms or pendants are interchangeable with other charms or pendants having said releasable clasps attached thereto;
and wherein the combined weight of the charms or pendants, the cords or chains, and releasable clasps provide the requisite tension to keep the frame securely in place on the nose of a wearer and aligned vertically in front of the eyes of the wearer.

2. The interchangeable eyewear system of claim 1 wherein said screw clasps comprise a first pair of screw clasps having either an internally or externally threaded portion connected to opposite sides of the frame and a corresponding externally or internally threaded portion connected to the proximal end of the cord or chain for releasably attaching the cord or chain to the end piece of the frame; and a second pair of screw clasps having an internally or externally threaded portion connected to the distal ends of the cords or chains and a corresponding externally or internally threaded portion is connected to the ornamental charm or pendant for releasably attaching the charm or pendant to the distal end of the cord or chain.

3. The interchangeable eyewear system of claim 2 wherein said system further comprises a first pair of rings, each ring of said first pair of rings inserted into an opening in the end piece of the frame, and a second pair of rings, where said corresponding externally or internally threaded portion of said second pair of screw clasps is connected to the second pair of rings, each ring of said second pair of rings inserted into an opening in the ornamental charm or pendant.

4. The interchangeable eyewear system of claim 3 wherein the ring is a jump ring or a split ring.

5. The interchangeable eyewear system of claim 1 wherein said magnetic clasps comprise a first pair of magnetic clasps having a first portion connected to opposite sides of the frame, and a second portion connected to the proximal ends of the cord or chain, for releasably attaching each cord or chain to the end piece of the frame; and a second pair of magnetic clasps having a first portion connected to the distal ends of each cord or chain, and a second portion for releasably attaching the charm or pendant to the distal end of the cord or chain.

6. The interchangeable eyewear system of claim 5 further wherein said first portion of said first pair of magnetic clasps is connected to said frame by a first pair of rings, each ring inserted into an opening in an end piece of the frame, and said second portion of said first pair of magnetic clasps is connected to the proximal end of the cord or chain by a second pair of rings, and further wherein said first portion of said second pair of magnetic clasps is connected to the distal end of said cord or chain by a third set of rings, and a second portion of said second pair of magnetic clasps is connected to a fourth set of rings, each of the fourth set of rings inserted into an opening in the ornamental charm or pendant.

7. The interchangeable eyewear system of claim 6 wherein the ring is a jump ring or a split ring.

8. The interchangeable eyewear system of claim 1 wherein said flexible chains or cords have a length with a range of about 13-25 cm.

9. The interchangeable eyewear system of claim 8 wherein said flexible chains or cords have a length with a range of about 15-21 cm.

10. The interchangeable eyewear system of claim 9 wherein said flexible chains or cords are at least about 15 cm in length.

11. The eyeglass or sunglass system of claim 1 wherein the cord is a beaded cord.

12. The eyeglass or sunglass system of claim 1 wherein the lenses are prescription lenses.

13. The sunglass system of claim 1 wherein the lenses are polarized lenses.

14. The eyeglass or sunglass system of claim 1 wherein the charms or pendants are made of cellulose acetate.

15. A method of making an interchangeable eyewear system comprising soft temples or stems made of cord or chain, said method comprising:
releasably connecting a proximal end of said chain or cord to an eyeglass or sunglass frame using a first pair of screw clasps, magnetic clasps or combination thereof, and
releasably connecting a distal end of said chain or cord to an ornamental charm or pendant using a second pair of screw clasps, magnetic clasps or combination thereof,
wherein the chains or cords are interchangeable with other chains or cords having said releasable clasps attached thereto; wherein the charms or pendants are interchangeable with other charms or pendants having said releasable clasps attached thereto;
and wherein the combined weight of the charms or pendants, the cords or chains, and releasable clasps provide the requisite tension to keep the frame securely in place on the nose of a wearer and aligned vertically in front of the eyes of the wearer.

16. The method of claim 15 further comprising:
(a) inserting a first ring into a first opening in a first end piece of the frame, said first ring connected to a first portion of the first screw clasp having internal or external threads;
(b) inserting a second ring into a second opening in a second end piece of the frame, said second ring connected to a first portion of the first screw clasp having internal or external threads;
(c) connecting each proximal end of the chains or cords to a second portion of the first screw clasp having corresponding external or internal threads, wherein the first and second portions of the screw clasps are joinable to connect the proximal ends of the cords or chains to the end pieces of the frame;
(d) connecting a first portion of a second screw clasp having internal or external threads to the distal end of each of the cords or chains;
(e) connecting a second portion of a second screw clasp having corresponding external or internal threads to a ring inserted into an opening of a pendant or charm;
wherein the chains or cords are interchangeable with other chains or cords having the same portions of screw clasps attached thereto; wherein the charms or pendants are interchangeable with other charms or pendants having the same portions of screw clasps attached thereto; and
wherein the combined weight of the charms or pendants, the cords or chains, the rings, and screw clasps provide the requisite tension to keep the frame securely in place on the nose of a wearer and aligned vertically in front of the eyes of a wearer when the cords or chains are pulled toward and draped over the ears of the wearer.

17. The method of claim 16 wherein said chains or cords are at least about 15 cm in length.

18. The method of claim 15 further comprising:
(a) inserting a first ring into a first opening in a first end piece of the frame, said first ring connected to a first portion of the magnetic clasp;
(b) inserting a second ring into a second opening in a second end piece of the frame, said second ring connected to a first portion of a magnetic clasp; connecting each proximal end of two chains or cords to a second portion of a magnetic clasp having opposite polarity to the first portion of the magnetic clasp, wherein the first and second portions of the magnetic clasp are joinable to connect the proximal ends of the cords or chains to the end pieces of the frame;
(c) connecting a first portion of a second magnetic clasp to the distal end of each of the cords or chains; connecting a second portion of the second magnetic clasp having opposite polarity to the first portion of the second magnetic clasp to a ring inserted into an opening of a pendant or charm;
wherein the chains or cords are interchangeable with other chains or cords having portions of magnetic clasps with the same polarity attached thereto; wherein the charms or pendants are interchangeable with other charms or pendants having portions of magnetic clasps with the same polarity attached thereto; and wherein the combined weight of the charms or pendants, the cords or chains, the rings, and magnetic clasps provide the requisite tension to keep the frame securely in place on the nose of a wearer and aligned vertically in front of the eyes of a wearer when the cords or chains are pulled toward and draped over the ears of the wearer.

19. The method of claim 18 wherein said chains or cords are at least about 15 cm in length.
